(19) United States
(12) Patent Application Publication
(10) Pub. No.: US 2024/0375015 A1
(43) Pub. Date: Nov. 14, 2024

(54) GAME SYSTEM, COMPUTER-READABLE RECORDING MEDIUM, AND MANAGEMENT SERVER DEVICE

(71) Applicant: Square Enix Co. Ltd., Tokyo (JP)

(72) Inventors: Naoyuki TAMATE, Tokyo (JP); Yosuke TOYODA, Tokyo (JP)

(21) Appl. No.: 18/660,904

(22) Filed: May 10, 2024

(30) Foreign Application Priority Data
May 12, 2023 (JP) 2023-079129

(51) Int. Cl. A63F 13/79; A63F 13/44

(52) U.S. Cl. CPC A63F 13/79; A63F 13/44

(57) ABSTRACT

Game system including terminal device operated by user, web server device, and management server device, wherein the management server device and/or the terminal device may be connected to a distributed ledger network, the web server device includes a display mode changing unit configured to change a display mode of web content included in a service to be provided by an operation of a user, the management server apparatus includes an appending unit configured to append a non-substitution token (hereinafter, referred to as NFT) to a user when a predetermined appending condition including a condition related to the display mode is satisfied.

### CROSS-REFERENCE TO RELATED APPLICATION(S)

The present disclosure claims priority to Japanese Patent Application No. 2023-079129, filed on May 12, 2023, the disclosure of which is expressly incorporated herein by reference in its entirety for any purpose.

### BACKGROUND

The present invention relates to a game system, a game program, a management server device, and a control method.

Conventionally, there is a game in which a web browser is used to proceed while communicating between a server device and a client terminal device, that is, a so-called browser game. Games utilizing distributed ledger technology (Distributed Ledger Technology (DLT)) or blockchain technology have also begun to be offered (see, e.g., “CRYPTO SPELLS”, [online], CryptoGames, [search on Nov. 29, 2022], Internet <URL: https://cryptospells.jp/>).

### SUMMARY

In a conventional game, an item is not given based on a result of changing a display mode of the game based on an operation of a user.

It is an object of at least one embodiment of the present invention to provide a new game system using a browser.

According to a non-limiting aspect of the present invention, there is provided a game system including: a terminal device operated by a user; a web server device; and a management server device, wherein the management server device and/or the terminal device are connectable to a distributed ledger network, the web server device includes display mode changing means for changing a display mode of web content included in a service to be provided by the user's operation, and the management server device includes, a game system comprising: an appending unit configured to append a non-substitution token (hereinafter, referred to as NFT) to a user when a predetermined appending condition including a condition related to the display mode is satisfied.

According to a non-limiting aspect, a game program according to the present invention is a game program to be installed in a management server device in a game system including a terminal device operated by a user, a web server device, and a management server device, wherein the management server device and/or the terminal device are connectable to a distributed ledger network, and the management server device is connected to the distributed ledger network, a non-transitory computer-readable storage medium storing a game program causing a computer to function as an appending unit that appends a non-fungible token (NFT) to a user when a predetermined appending condition including a condition related to a display mode of web content included in a service provided by a web server device is satisfied.

According to a non-limiting aspect, a management server device according to the present invention is a management server device in a game system including a terminal device operated by a user, a web server device, and a management server device, wherein the management server device and/or the terminal device can be connected to a distributed ledger network, and the management server device satisfies a predetermined granting condition including a condition regarding a display mode of web content included in a service provided by the web server device, the alternative property to the user token (hereinafter, referred to as NFT) is applied to the application means, the management server apparatus.

According to a non-limiting aspect, a control method according to the present invention is a control method executed in a game system including a terminal device operated by a user, a web server device, and a management server device, wherein the management server device and/or the terminal device are connectable to a distributed ledger network, and the method includes the steps of: changing a display mode of web content included in a service to be provided in the web server device by a user's operation; and changing the display mode of web content included in the service to be provided in the management server device, a control method including a step of giving a non-substitution token (hereinafter, referred to as NFT) to a user when a predetermined giving condition including a condition related to the display mode is satisfied.

One or more deficiencies are solved by embodiments of the present invention.

### BRIEF DESCRIPTION OF THE DRAWINGS

FIG. 1 is a block diagram showing a configuration of a game system corresponding to at least one embodiment of the present invention.

FIG. 2 is a flowchart of an execution process corresponding to at least one of the embodiments of the present invention.

FIG. 3 is a block diagram showing a configuration of a game system corresponding to at least one of the embodiments of the present invention.

FIG. 4 is a block diagram showing a configuration of a game system corresponding to at least one of the embodiments of the present invention.

FIG. 5 is a flowchart of an execution process corresponding to at least one of the embodiments of the present invention.

FIG. 6 is a diagram illustrating a change in a display mode of content corresponding to at least one of the embodiments of the present invention.

FIG. 7 is a diagram illustrating an assignment condition master table corresponding to at least one embodiment of the present invention.

FIG. 8 is a diagram illustrating a token master table corresponding to at least one embodiment of the present invention.

FIG. 9 is a flowchart of a reward setting process corresponding to at least one of the embodiments of the present invention.

### DESCRIPTION OF EMBODIMENTS

Hereinafter, embodiments of the present invention will be described with reference to the accompanying drawings. Hereinafter, the description of the effects is one aspect of the effects of the embodiment of the present invention and is not limited to those described here. Further, the description of the content described as an example of a certain embodiment may be omitted in other embodiments. Furthermore, descriptions of operations and processes that are not related to the characteristic portions of the embodiments may be omitted. The order of the respective processes included in the flowchart described below is unequal as long as no contradiction or mismatch occurs in the contents of the processes.

### First Embodiment

An outline of a first embodiment of the present invention will be described. Hereinafter, as a first embodiment, a game system including a terminal device operated by a user, a web server device, and a management server device will be described as an example. The terminal devices, web server devices, and/or management server devices may be communicatively connectable to each other. The management server apparatus and/or the terminal apparatus can be connected to a distributed ledger network.

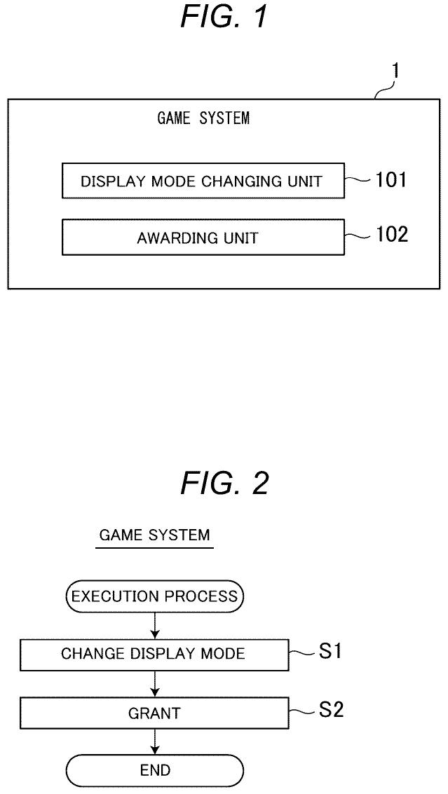

FIG. 1 is a block diagram showing a configuration of a game system corresponding to at least one embodiment of the present invention. The game system 1 may include at least a display mode changing unit 101 and an awarding unit 102.

The display mode changing unit 101 has a function of changing the display mode of the web content included in the service provided by the web server device by a user's operation. The granting unit 102 has a function of granting a non-substitution token (hereinafter, referred to as NFT) to the user by the management server device when a predetermined granting condition including a condition related to the display mode is satisfied.

FIG. 2 is a flowchart of an execution process corresponding to at least one of the embodiments of the present invention. The game system 1 changes the display mode of the web content included in the service provided by the web server device by an operation of the user (step S1). Next, the game system 1 gives a non-substitution token (NFT) to the user by the management server device when a predetermined giving condition including the condition related to the display mode is satisfied (step S2), and ends the processing.

As one aspect of the first embodiment, a new game system using a browser can be provided.

In the first embodiment, the “terminal device” refers to, for example, a stationary game machine, a portable game machine, a wearable terminal, a desktop or notebook personal computer, a tablet computer, or a PDA, and may be a portable terminal such as a smartphone having a touch panel sensor on a display screen. A “server device” such as a web server device or a management server device refers to, for example, a device that executes processing in response to a request from a terminal device.

The term “service” refers to, for example, a technology capable of externally using a server device, and more specifically, a service provided on the Internet. The “content” refers to, for example, an electronic content realized by a program, and more specifically, refers to an image related to a game, a moving image, a website capable of interacting with a user, and the like. Content is a concept included in a service. The term “providing” refers to, for example, making a state owned by the user regardless of chargeable or free.

### Second Embodiment

An outline of a second embodiment of the present invention will be described. Hereinafter, as a second embodiment, a game system including a terminal device operated by a user, a web server device, and a management server device will be described as an example. The terminal devices, web server devices, and/or management server devices may be communicatively connectable to each other. The management server apparatus and/or the terminal apparatus can be connected to a distributed ledger network.

### Game Summary

An outline of a game according to a second embodiment of the present invention will be described. An example of the game is a treasure search game in which a display mode of web content displayed on a terminal device is changed by a user's operation, and when a predetermined position to be a correct answer is selected, an item is given to the user. In this case, the item to be granted is preferably a non-alternative token (NFT). However, the present disclosure is not limited to this game, and is within the scope applicable to those skilled in the art by the present disclosure.

### Game System

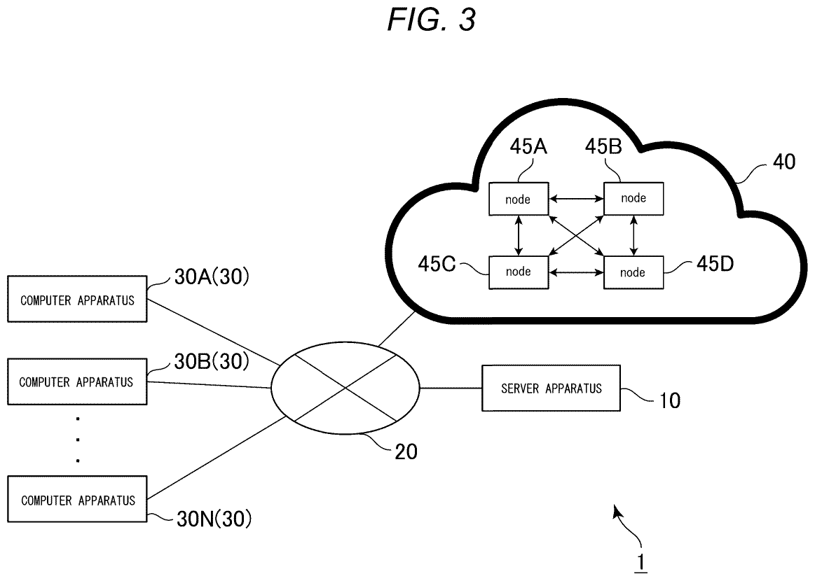

FIG. 3 is a block diagram showing a configuration of a game system corresponding to at least one of the embodiments of the present invention. As illustrated, the game system (system) 1 includes a management server device 10, a web server device 15, a communication network 20, client terminal devices 30 (30A, 30B, . . . , 30N: N is a natural number) used by a plurality of users (players) who play a video game (game), and a distributed ledger network (also referred to as a block chain network) 40 connected so as to be able to share contents of the distributed ledger.

The configuration of the game system 1 is not limited thereto, and for example, the management server device 10 and/or the web server device 15 may be configured by a plurality of server devices, or may be configured by a virtual server device using a cloud computing technology. The management server device 10, the web server device 15, and the terminal device 30 are communicably connected to each other. The terminal device 30 may not be always connected to the management server device 10 and the web server device 15, and may be connected as necessary.

### Management Server Device and Web Server Device

As an example, the management server device 10 and the web server device 15 include at least a control unit, a RAM, a storage unit, and a communication interface, and are connected to each other by an internal bus. The controller may comprise an internal timer. The communication interface may also be used to synchronize with an external server. As a result, the actual time can be acquired.

The management server device 10 and the web server device 15 can provide various electronic services, not limited to games, to users.

### Communication Network

The communication network 20 may be, for example, the Internet or a LAN, as long as communication is possible between connected devices.

### Terminal Device

The terminal device 30 includes, for example, a control unit, a RAM, a storage unit, a sound processing unit, a graphics processing unit, a communication interface, and an interface unit, which are connected to each other by an internal bus. The graphics processing unit is connected to the display unit. The display unit may include a display screen and a touch input unit that receives an input by a user's contact with the display unit.

The touch input unit may be, for example, a touch input unit that can detect a contact position using any method such as a resistive film method, a capacitive method, an ultrasonic surface acoustic wave method, an optical method, or an electromagnetic induction method used in a touch panel, and the method is not particularly limited as long as the touch input unit can recognize an operation by a touch operation of a user. This is a device capable of detecting the position of a finger or the like when an operation such as pressing or moving the upper surface of the touch input unit with a finger, a stylus, or the like is performed.

An external memory (for example, an SD card or the like) may be connected to the interface unit. Data read from the external memory is loaded into the RAM, and arithmetic processing is executed by the control unit. The communication interface can be connected to a communication network wirelessly or by wire, and can receive data via the communication network. The data received via the communication interface is loaded into the RAM in the same manner as the data read from the external memory, and arithmetic processing is performed by the control unit.

The terminal device 30 may include a sensor such as a proximity sensor, an infrared sensor, a gyro sensor, or an acceleration sensor. The terminal device 30 may include an imaging unit that includes a lens and captures an image via the lens. Further, the terminal device 30 may be a wearable terminal device.

### Distributed Ledger Network

The distributed ledger network 40 may include a plurality of nodes 45, such as computing devices, that store the distributed ledger in a storage device. In the figure, nodes 45A to 45D are shown as examples, but the number of nodes is not limited to four.

The node computers 45A-45D manage the distributed ledger using blockchain technology. For example, the node computer 45A acquires data related to the transaction of the token to be recorded. The node computer 45A creates a block including the acquired data and adds the block to the blockchain. The node computer 45A transmits information of the added blocks to the node computers 45B to 45D. The node computers 45B-45D verify the correctness of the received blocks. When the verification succeeds, the node computers 45B to 45D add a block to the blockchain. The node computers 45A to 45D determine the blockchain according to, for example, the number of blocks to be linked (the number of approvals). As a result, the same distributed ledger is stored across the plurality of node computers 45A to 45D constituting the distributed ledger network 40. The stored data is appropriately encrypted.

Since the hardware configuration of the node computers 45A to 45D may be the same as or similar to the hardware configuration of the terminal device 30 or the hardware configuration of the management server device 10 or the web server device 15, detailed description thereof will be omitted.

In the distributed ledger network 40, data of a unit called a block is generated, and a block chain is formed by connecting the data as a chain. By storing the same distributed ledger in each node, the information can be kept secure. The management server device 10, the web server device 15, and/or the terminal device 30 may be communicably connected to the distributed ledger network 40. The management server device 10, the web server device 15, and/or the terminal device 30 may function as nodes included in the distributed ledger network 40.

In the distributed ledger network 40, token transactions are possible. As the distributed ledger network 40, for example, an existing platform such as Ethereum may be employed. The distributed ledger network 40 may also possess marketplace functions capable of issuing (generating, mint) and trading NFTs. Since these blockchain techniques have a general configuration, detailed description thereof will be omitted.

### Functional Description

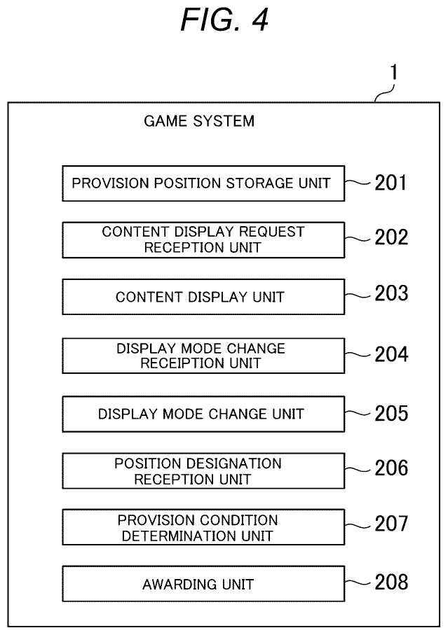

Functions of the game system 1 according to the second embodiment will be described. FIG. 4 is a block diagram showing a configuration of a game system corresponding to at least one of the embodiments of the present invention.

The game system 1 may include a provision position storage unit 201, a content display request reception unit 202, a content display unit 203, a display mode change reception unit 204, a display mode change unit 205, a position designation reception unit 206, a provision condition determination unit 207, and a provision unit 208.

The assignment position storage unit 201 has a function of storing position information to which an NFT can be assigned. The content display request receiving unit 202 has a function of receiving a content display request by a user's operation. The content display unit 203 has a function of outputting information for displaying content.

The display mode change receiving unit 204 has a function of receiving a display mode change request. The display mode changing unit 205 has a function of changing the display mode of the web content included in the service provided by the web server device.

The position designation receiving unit 206 has a function of receiving designation of a position on the content by a user's operation. The application condition determination unit 207 has a function of determining whether or not the application condition is satisfied. The awarding unit 208 has a function of awarding a reward when the awarding condition determination unit 207 determines that the awarding condition is satisfied.

### Execution Process

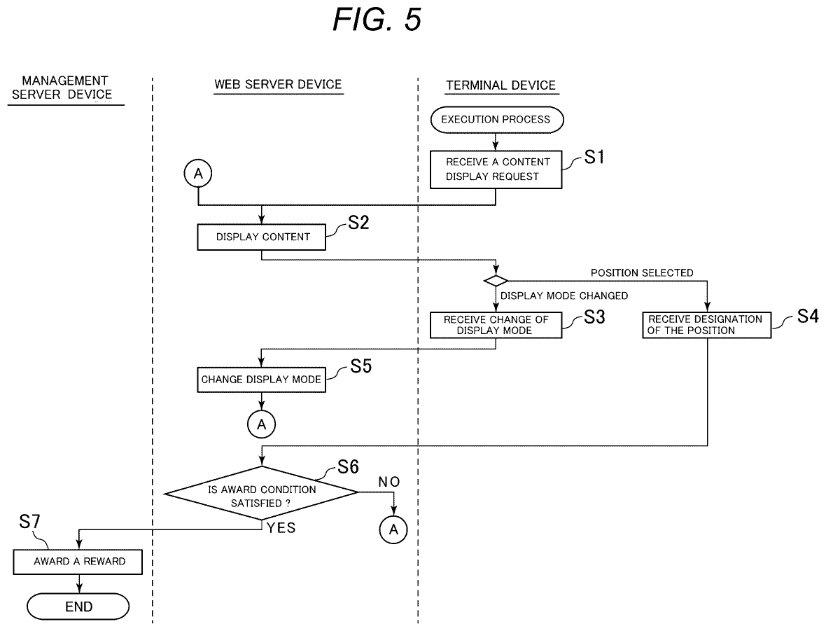

Next, the execution process in the second embodiment of the present invention will be described. FIG. 5 is a flowchart of an execution process corresponding to at least one of the embodiments of the present invention.

The game system 1 receives a content display request by a user's operation in the terminal device 30 (step S1). Next, the game system 1 outputs information for displaying the content in the web server device 15, and displays the information in the terminal device 30 (step S2).

The user can change the display mode or specify the position of the displayed content. When the display mode is changed, the game system 1 receives the change of the display mode of the content by the operation of the user in the terminal device 30 (step S3).

Next, the game system 1 changes the display mode of the content (step S5). After changing the display mode of the content, the game system 1 outputs information for displaying the changed content (step 2).

### Display Mode Change

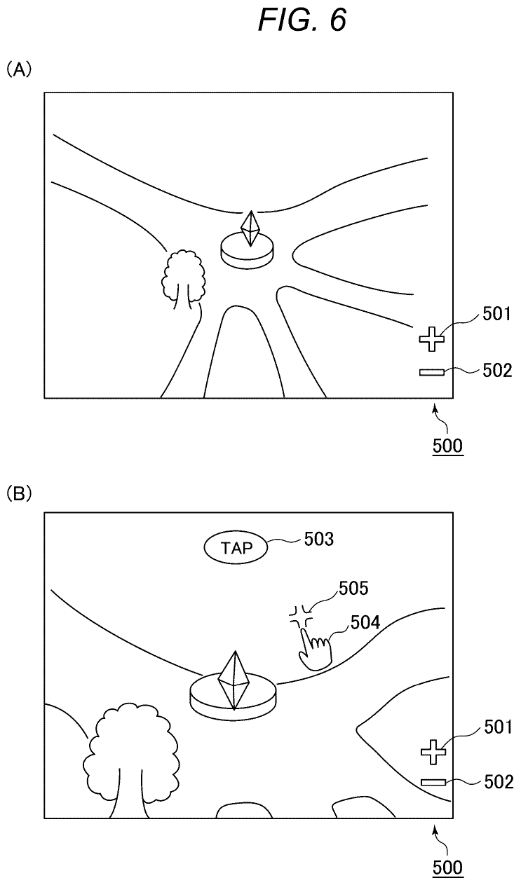

FIG. 6 is a diagram illustrating a change in a display mode of content corresponding to at least one of the embodiments of the present invention. FIG. 6A is a diagram illustrating a state in which a two-dimensional content screen 500 is displayed on a browser as an example. On the content screen 500, an image that can be designated by the user and a component (e.g., a button or the like) for changing the display mode can be displayed. In FIG. 6A, as an example of the display mode change, a screen configured to be capable of changing the enlargement ratio of the content is shown. The user can change the enlargement ratio of the content by pressing the enlargement button 501 or the reduction button 502. Although not shown, a button for returning to the original scale may be provided.

FIG. 6B is an enlarged view of the content screen of FIG. 6A by a predetermined ratio, as an example. In the content screen 500, the monument displayed at the center is displayed larger than the screen shown in FIG. 6A. At this time, in a case where an application condition described later is satisfied, an image 503 that allows the user to visually recognize that the application condition is satisfied may be displayed. Alternatively, it may be designed to emit a sound that is not visually recognized by the user and can be confirmed by the auditory sense.

The user can designate an arbitrary location on the content screen 500. The location designated by the user can be indicated by the cursor 504 using an input device such as a mouse operation or a tap operation. The terminal device 30 may display a mark 505 indicating a designated position when receiving a designation operation by clicking, double tapping, or the like.

The range of the designated position may be changed according to the enlargement ratio. For example, when the designated range at the position designated in the state of the enlargement ratio of 100% is 10 pixels, control may be performed so that only 5 pixels are designated in the state of the enlargement ratio of 50%. That is, it can be said that the apparent size of the mark 505 indicating the designated position is controlled so as not to change depending on the magnification.

The change of the display mode of the content is, for example, a change of the enlargement ratio, but is not limited thereto. For example, a change in the color of the content, a change in the brightness of the content, a change in the number of pixels of the display, a change in the style such as a display of a painting style, a filtered image, or the like may be included.

Return to the flowchart of FIG. 5. The game system 1 receives the designation of the position by the operation of the user in the terminal device 30 (step S4). Next, the game system 1 determines whether or not the award condition is satisfied (step 6).

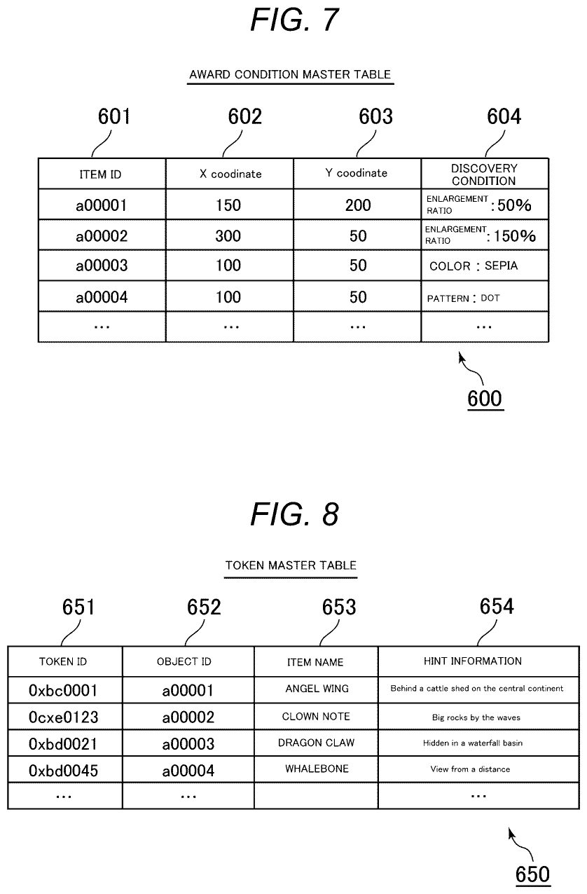

FIG. 7 is a diagram illustrating an assignment condition master table corresponding to at least one embodiment of the present invention. The assignment condition master table 600 may store an X coordinate 602, a Y coordinate 603, and a discovery condition 604 of an arrangement location in association with an object ID 601 to be assigned. When the position designated by the user in step S4 includes the X coordinate 602 and the Y coordinate 603 and the display mode designated by the user in step S3 matches the discovery condition 604, the game system 1 determines that the object is to be provided. The coordinates of the arrangement location may have a range, and in this case, the position designated by the user may be included in the range.

In the discovery condition 604, as shown in the figure, a display mode after the change can be set, such as a size of the enlargement ratio, a change in color, or a case where the content is filtered into a dot pattern.

When the award condition is satisfied (YES in step S6), game system 1 awards a reward to the user in management server device 10 (step S7), and ends the process. When the provision condition is not satisfied (NO in step S6), game system 1 displays the content again (step S2).

### Reward Awarding

A case where the reward to be given is a token will be described. FIG. 8 is a diagram illustrating a token master table corresponding to at least one embodiment of the present invention. The token master table 650 may store an object ID 652, an item name 653, and hint information 654 in association with a token ID 651.

The reward can be given in a flow in which, for example, the web server device 15 transmits the object ID 601 satisfying the giving condition to the management server device 10, and the management server device 10 gives the token of the token ID 651 corresponding to the object ID 652 equal to the object ID 601 to the user. The token may be issued in the distributed ledger network 40 by the management server device 10 that has received the information on the satisfaction of the granting condition from the web server device 15, or the token may be issued in advance, stored in the wallet of the management server device 10, and transferred to the wallet of the user in response to the satisfaction of the granting condition.

It should be noted that the design of the assignment condition master table 600 and the token master table 650 may be appropriately changed, and may be appropriately changed by those skilled in the art as long as the flowchart can be executed.

### Setting Rewards

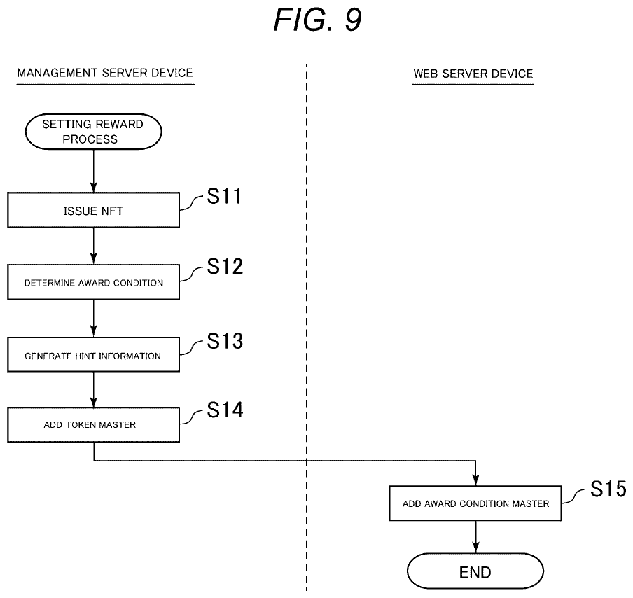

A reward setting flow will be described. FIG. 9 is a flowchart of a reward setting process corresponding to at least one of the embodiments of the present invention. The game system 1 issues an NFT serving as a reward in the management server device 10 (step S11). The issuance of the NFT is executed in the distributed ledger network 40.

Next, the game system 1 determines an award condition (step S12). As the application condition, at least the arrangement position and the display mode to be applied are determined. The determination may be performed at random, or may be performed with reference to a past arrangement history so as to be arranged at a position different from a position given in the past.

Next, the game system 1 generates hint information (step S13). As the hint information, for example, information corresponding to the arrangement position determined in step S12 may be held as master data in advance, or the hint information may be generated by classifying images corresponding to the arrangement position using the AI technique.

Next, the game system 1 adds information to the token master table 650 using the information on the NFT issued in step S1, the granting condition determined in step S12, and the hint information generated in step S13 (step S14). Next, the game system 1 adds information on the awarding condition to the awarding condition master table 600 stored in the web server device (step S15), and ends the processing.

Although the reward setting process has been described as having a main function in the management server device 10, the reward setting process is not limited to this. The web server device 15 may have a function, or may be designed to be controlled by another server device.

In the second embodiment, the content to be displayed is a two-dimensional image. For example, it may be an image of a three-dimensional space.

In the second embodiment, the reward to be granted is preferably an NFT, but is not limited to an NFT. For example, the object may be an object usable in a game, a coupon usable in the real world, or the like.

In the second embodiment, an upper limit may be set to the quantity of rewards to be granted. By doing so, it is possible to perform control so as not to discover objects that have been placed in the past and that have been discovered, and it is possible to reduce the operation burden and motivate early discovery of rewards.

In the second embodiment, an example in which the display mode is changed by the operation of the user has been described, but the present invention is not limited thereto. For example, when a predetermined condition is satisfied, the game system 1 may automatically select, as a hint, a display mode in which a reward is given.

In the second embodiment, the application conditions are not limited to those described above. For example, a limit may be imposed on the number of times the designation of the position from the user is accepted. Alternatively, the position in the three-dimensional virtual space may be designated by setting the Z coordinate. Alternatively, for example, the time from the time when the user starts the game to the time when the designation of the position is accepted may be limited, and the predetermined limited time may be counted down.

As an example of the premise of the game of the second embodiment, it may be determined in advance that the user is in a state in which the user can trade the NFT. For example, when starting a game, it may be necessary for a user to have an account (account, wallet) in a distributed ledger network. Alternatively, the account may be confirmed at the stage of giving the reward.

In the second embodiment, the given NFT is not limited to the hint of the next reward. For example, it is useful to provide various methods of use, such as obtaining advantageous effects in the game when possessed, advancing to next content, being used in other services, and being entitled to participate in offline meeting.

In the second embodiment, the hint information of the reward may be provided to another service different from the service provided by the web server device 15 (second information providing means). Specific examples of the other services include an SNS and a homepage.

As one aspect of the second embodiment, a new game system using a browser can be provided.

As one aspect of the second embodiment, a game system with higher taste can be provided by a configuration in which a user changes a display mode and specifies a position to obtain a reward.

As the “terminal device”, “server device”, “service”, “content”, “display mode”, and “assignment” in the second embodiment, the contents described in the first embodiment can be adopted within a necessary range.

In the second embodiment, the term “reward” refers to, for example, a reward that provides a benefit to a user's action.

In the present disclosure, the game system 1 includes all the functions, but is not limited thereto. For example, the functions may be distributed to the management server device 10, the web server device 15, the terminal device 30, and the distributed ledger network 40.

The contents described in each of the above embodiments can be appropriately designed by a person skilled in the art by changing the contents.

### APPENDIXES

In the above description of the embodiments, the following invention is described so that those skilled in the art can practice the invention.
[1] A terminal device operated by a user, a web server device, a game system including a management server device, the management server device and/or the terminal device may be connected to a distributed ledger network, a web server device is configured to,
display mode changing means for changing display mode of web content included in service to be provided by user operation
Comprising,
the management server device includes,
appending means for appending a non-alternative token (hereinafter, referred to as NFT) to a user when a predetermined appending condition including the condition relating to the display mode is satisfied.
A gaming system comprising:
[2] The web server device includes, application position storage means for storing position information to which the NFT can be applied.
Comprising,
The application condition of the application means is,
The display mode is a predetermined mode; and,
A position operated by the user is a position corresponding to the position information.
The game system according to [1], including:
[3] The management server device includes,
A first information providing means for providing information related to position information to which the NFT can be given, the position information being stored in the given position storing means,
NFT issuing means for issuing NFT
Comprising,
The game system according to [2], including information related to position information capable of giving the NFT to an NFT to be issued.

[4] The game system may further include another service management server device, Second information providing means for providing information on position information to which the NFT can be assigned in a service provided by another service management server device different from the web server device.
The game system according to [1] or [2], including:
[5] The management server device is further configured to,
Issuance information transmission means for transmitting issuance information related to the issued NFT to the web server device after issuing the NFT
Comprising,
The web server device is further configured to,
Position information determination means for determining position information capable of providing NFT
Comprising,
The game system according to [3], wherein the assignment position storage means stores position information capable of assigning the NFT in association with the issuance information.
[6] The web server device is further configured to,
Applicability image display means for displaying an image visually recognizable by the user on the web content when the display mode of the display mode changing means satisfies the applicability condition.
The game system according to [1] or [2], which is caused to function as:
[7] The web server device is further configured to,
A time measuring means for measuring a time limit,
Designated number measuring means for measuring designated number of times of position operated by user
The game system according to [2], further comprising: a timer configured to control the game system to terminate the game when the timer exceeds a time limit or when the specified number of times measurement unit exceeds a predetermined number of times limit.
[8] The game system according to [1] or [2], wherein the display mode changing unit changes an enlargement ratio of the display of the web content by an operation of the user.
[9] A terminal device operated by a user,
A web server device,
A game program to be installed in a management server device in a game system including the management server device,
The management server device and/or the terminal device may be connected to a distributed ledger network,
The management server device may include,
Appending means for appending a non-substitution token (hereinafter referred to as NFT) to a user when a predetermined appending condition including a condition related to a display mode of web content included in a service provided by a web server device is satisfied. Game program, wherein allowing to function as:
[10] A management server device in which the game program according to [9] is installed.
[11] A terminal device operated by a user,
A web server device,
A control method executed in a game system including a management server device,
The management server device and/or the terminal device may be connected to a distributed ledger network,
In the web server device, a display mode of web content included in a service to be provided may be changed by a user's operation,
In the management server apparatus, an NFT may be provided to the user when a predetermined providing condition including a condition related to the display mode is satisfied.
A control method comprising:

### INDUSTRIAL APPLICABILITY

According to one embodiment of the present invention, the present invention is useful as a game system, a program, a management server device, and a control method capable of providing a new game system using a browser.

What is claimed is:

1. A game system comprising:
a terminal device configured to be operated by a user;
a web server device; and
a management server device,
wherein at least one of the management server device or the terminal device is configured to be connected to a distributed ledger network,
wherein at least one of the management server device or web server device is configured to provide a service,
wherein the web server device is configured to change a display mode of a web content included in the service based on an operation of the user, and
wherein the management server device is configured to assign a non-fungible token (NFT) to a user when a predetermined granting condition including a condition related to the display mode is satisfied.

2. The gaming system of claim 1, wherein the web server comprises a storage device configured to store position information that is configured to be assigned the NFT,
wherein the granting condition comprises:
when the display mode is a predetermined mode; and
when a position operated by the user corresponds to the position information.

3. The game system according to claim 2, wherein the management server device is further configured to:
provide information related to the stored position information, and,
issue an NFT comprising the provided information.

4. The gaming system according to claim 1, further comprising another service management server device configured to provide information related to position information that is configured to be assigned the NFT in a service provided by another service management server device different from the web server device.

5. The game system according to claim 3, wherein the management server device is further configured to transmit issuance information related to the issued NFT to the web server device,
wherein the web server device is further configured to determine position information configured to be assigned the NFT, and
wherein the web server device is configured to store the position information in association with the issuance information.

6. The game system according to claim 1, wherein the web server device is further configured to display an image visually recognizable by the user on the web content when the display mode satisfies the granting condition.

7. The game system according to claim 2, the web server device further comprises:
a timer configured to measure an elapsed time, and
a counter configured to count a number of times of position designations operated by user,
wherein the timer is configured to control the game system to terminate the game when the elapsed time exceeds a time limit or when the number of times exceeds a predetermined number limit.

8. The game system according to claim 1, wherein the web server device is configured to change an enlargement ratio of the display of the web content by an operation of the user.

9. A non-transitory computer-readable recording medium having recorded thereon a game program causing a management server device to perform functions comprising:
assigning an NFT to a user when a predetermined granting condition including a condition related to a display mode of a web content included in a service provided by a web server device is satisfied.

10. A game system comprising:
a terminal device configured to be operated by a user;
a web server device; and
a management server device,
wherein at least one of the management server device or the terminal device is configured to be connected to a distributed ledger network,
wherein the management server device is configured to assign an NFT to a user when a predetermined granting condition including a condition related to the display mode is satisfied.
